(19) United States
(12) Patent Application Publication
(10) Pub. No.: US 2025/0006446 A1
(43) Pub. Date: Jan. 2, 2025

(54) CONTACTOR AND AIR CONDITIONING SYSTEM

(71) Applicant: XIAMEN HONGFA ELECTRICAL SAFETY & CONTROLS CO., LTD., Xiamen (CN)

(72) Inventors: Xiaoju JI, Xiamen (CN); Xieli ZHANG, Xiamen (CN); Yanxiong YU, Xiamen (CN); Junfeng YE, Xiamen (CN)

(21) Appl. No.: 18/474,360

(22) Filed: Sep. 26, 2023

(30) Foreign Application Priority Data
Jun. 29, 2023 (CN) 202310786062.9

(51) Int. Cl. H01H 50/54; H01H 50/02

(52) U.S. Cl. CPC H01H 50/54; H01H 50/026

(57) ABSTRACT

A contactor and an air conditioning system are provided. The contactor includes a main body which is provided with a first opening; a contact unit which is disposed in the main body, the contact unit includes a movable contact part and a stationary contact part; an electromagnetic unit which is disposed in the main body, wherein the electromagnetic unit is configured to control the movable contact part to contact with or separate from the stationary contact part; an isolation structure which is disposed between the electromagnetic unit and the contact unit, the isolation structure is configured to block refrigerant entering from the first opening from entering a space where the movable contact part and the stationary contact part contact each other through the electromagnetic unit.

### CROSS-REFERENCE TO RELATED APPLICATION

This application claims the benefit of and priority to Chinese Patent Application No. 202310786062.9, entitled “Contactor and Air Conditioning System,” filed on Jun. 29, 2023, wherein the entire contents thereof are incorporated by reference in their entirety herein.

### TECHNICAL FIELD

The present disclosure generally relates to the technical field of air conditioning and, in particular, to a contactor and an air conditioning system.

### BACKGROUND

Existing air conditioning systems are widely used in residential or commercial buildings and other fields, and air conditioning systems need to use refrigerant for heat exchange to achieve the purpose of controlling indoor temperature. At first, refrigerants (such as R410A, etc.) with high global warming potential (GWP) were used, which had a great impact on the environment, so refrigerants with lower GWP value needs to be used instead, such as A2L.

In the process of turning on or off a traditional AC contactor, contact parts thereof will generate an arc, which generates enough energy to ignite the refrigerant, so the traditional contactor may be a potential ignition source. However, A2L refrigerant, as a low flammable refrigerant, will be ignited by a potential ignition source and explode under certain conditions. Therefore, A2L refrigerant has certain risks and low safety when used in air conditioning systems.

### BRIEF SUMMARY

According to one aspect of the present disclosure, a contactor is provided. The contactor includes: a main body, which is provided with a first opening; a contact unit, which is disposed in the main body, the contact unit comprising a movable contact part and a stationary contact part; an electromagnetic unit, which is disposed in the main body, the electromagnetic unit is configured to control the movable contact part to contact with or separate from the stationary contact part; an isolation structure, which is disposed between the electromagnetic unit and the contact unit, the isolation structure is configured to block refrigerant entering from the first opening from entering a space where the movable contact part and the stationary contact part contact each other through the electromagnetic unit.

According to exemplary embodiments of the present disclosure, the isolation structure is disposed between a side of the stationary contact part away from the movable contact part and the electromagnetic unit.

According to exemplary embodiments of the present disclosure, the contact unit further includes: a contact support, which is slidably disposed in the main body, and the contact support is configured to carry the movable contact part; the isolation structure is disposed on the contact support; and/or, the isolation structure is disposed in the main body.

According to exemplary embodiments of the present disclosure, the isolation structure includes: an isolation rib protruding from an outer wall of the contact support; where, the isolation rib is configured to extend along a width direction of the movable contact part; and there are a plurality of isolation ribs, the plurality of the isolation ribs are respectively disposed on both sides of the contact support along a length direction of the movable contact part.

According to exemplary embodiments of the present disclosure, the isolation structure includes: a barrier rib which at least partially surround an outside of the contact support and is connected to an inner wall of the main body; the barrier rib is configured to extend along a movement direction of the contact support; and/or, the barrier rib is configured to extend along a width direction of the movable contact part.

According to exemplary embodiments of the present disclosure, the isolation structure and the contact support are integrally formed; and/or, the main body and the isolation structure are integrally formed.

According to exemplary embodiments of the present disclosure, the main body is provided with a through hole, and the contact support is configured to penetrate through the through hole and is in sliding fit with thereof; where, a gap is provided between the isolation structure and the through hole; and/or, the isolation structure is disposed along an edge of the through hole and a gap is provided between the isolation structure and the contact support; an effective opening size d_{eff} of the gap is less than or equal to a threshold size of a standard opening limit; the threshold size of the standard opening limit is 22.3×Su^{-1.09} (in mm); where, Su represents the burning velocity of refrigerant, in cm/s.

According to exemplary embodiments of the present disclosure, the isolation structure includes a first isolation structure and a second isolation structure, the first isolation structure is capable of passing through the through hole, and the second isolation structure is disposed between the through hole and the electromagnetic unit; when the movable contact part and the stationary contact part are in a release state, the first isolation structure and the second isolation structure are disposed at both sides of the through hole along an attraction direction of the movable contact part and the stationary contact part, and (h3+h4)/2≤hmax, H−h1≤hmax; where, H is an attraction distance of the movable contact part relative to the stationary contact part, h1 is a distance between a side of the first isolation structure and a side of the through hole, two sides are far away from each other in the attraction direction of the movable contact part and the stationary contact part, h3 is a distance between a side of the first isolation structure and a side of the through hole, two sides are close to each other in the attraction direction of the movable contact part and the stationary contact part, h4 is a distance between a side of the second isolation structure and a side of the through hole, two sides are close to each other in the attraction direction of the movable contact part and the stationary contact part.

According to exemplary embodiments of the present disclosure, the isolation structure includes a first isolation structure which is capable of passing through the through hole; when the movable contact part and the stationary contact part are in a release state, the first isolation structure is disposed at a side of the through hole far away from the electromagnetic unit, h3≤hmax, H−h1≤hmax; where, H is an attraction distance of the movable contact part relative to the stationary contact part, h1 is a distance between a side of the first isolation structure and a side of the through hole, two sides are far away from each other in the attraction direction of the movable contact part and the stationary contact part, h3 is a distance between a side of the first isolation structure and a side of the through hole, two sides are close to each other in the attraction direction of the movable contact part and the stationary contact part.

According to exemplary embodiments of the present disclosure, the isolation structure is made of at least one of self-lubricating materials and wear-resistant materials.

According to exemplary embodiments of the present disclosure, the main body includes: a housing, the contact unit, the electromagnetic unit and the isolation structure are disposed in the housing, and the housing is provided with an open end; a cover plate, which is configured to cover the open end of the housing; the first opening is provided on the main body and corresponding to the electromagnetic unit.

According to another aspect of the present disclosure, an air conditioning system is provided. The air conditioning system includes the contactor of any one of the embodiments described above.

### BRIEF DESCRIPTION OF THE DRAWINGS

For a better understanding of the present disclosure, reference may be made to the embodiments shown in the following drawings. Parts in the drawings are not necessarily to scale, and the related elements may be omitted in order to emphasize and clearly explain the technical features of the present disclosure. In addition, the related elements or parts may be arranged differently as known in the art. In the drawings, the same reference numerals indicate the same or similar parts in the various drawings. The above and other features and advantages of the present disclosure will become more apparent by describing in detail exemplary embodiments thereof with reference to the accompanying drawings.

FIG. 1 is a schematic diagram showing the explosion structure of the contactor provided in the first embodiment of the present disclosure.

FIG. 2 is a schematic structural view of the contact support of the contactor provided by the first embodiment of the present disclosure in an unactivated state.

FIG. 3 is a cross-sectional view at A-A in FIG. 2.

FIG. 4 is a schematic structural view of the contact support of the contactor provided by the first embodiment of the present disclosure in an activated state.

FIG. 5 is a cross-sectional view at B-B in FIG. 4.

FIG. 6 is a schematic structural view of the contact support of the contactor provided by the first embodiment of the present disclosure.

FIG. 7 is a schematic structural view of the contactor provided by the first embodiment of the present disclosure.

FIG. 8 is a schematic diagram showing the effective opening size of the gap of the contactor provided by the first embodiment of the present disclosure.

FIG. 9 is a schematic diagram showing the cooperation between the isolation structure and the through hole of the contactor provided by the first embodiment of the present disclosure.

FIG. 10 is a schematic view showing that the second opening of the contactor provided by the first embodiment of the present disclosure is decomposed along the second direction and the third direction.

FIG. 11 is a schematic structural view of the main body of the contactor provided by the second embodiment of the present disclosure.

FIG. 12 is a schematic structural view of the contact support of the contactor provided by the second embodiment of the present disclosure in an unactivated state.

FIG. 13 is a cross-sectional view at C-C in FIG. 12.

FIG. 14 is a schematic structural view of the contact support of the contactor provided by the second embodiment of the present disclosure in an activated state;

FIG. 15 is a cross-sectional view at D-D in FIG. 14.

FIG. 16 is a schematic structural view of the contact support of the contactor provided by the third embodiment of the present disclosure.

FIG. 17 is a cross-sectional view showing the contact support of the contactor provided in the third embodiment of the present disclosure.

FIG. 18 is a schematic structural view of the contact support of the contactor provided by the third embodiment of the present disclosure in an unactivated state.

FIG. 19 is a cross-sectional view at E-E in FIG. 18.

FIG. 20 is a schematic structural view of the contact support of the contactor provided by the third embodiment of the present disclosure in an activated state.

FIG. 21 is a cross-sectional view at F-F in FIG. 20.

FIG. 22 is a schematic structural view of the main body of the contactor provided by the third embodiment of the present disclosure.

FIG. 23 is a cross-sectional view of the main body of the contactor provided by the third embodiment of the present disclosure.

FIG. 24 is a schematic structural view of the contact support of the contactor provided by the third embodiment of the present disclosure in an unactivated state.

FIG. 25 is a cross-sectional view at G-G in FIG. 24.

FIG. 26 is a schematic structural view of the contact support of the contactor provided by the third embodiment of the present disclosure in an activated state.

FIG. 27 is a cross-sectional view at H-H in FIG. 26.

FIG. 28 is a first schematic structural view of the contact support of the contactor provided by the third embodiment of the present disclosure;

FIG. 29 is a front schematic diagram of the contact support of the contactor provided by the third embodiment of the present disclosure.

FIG. 30 is a cross-sectional view of the contact support of the contactor provided by the third embodiment of the present disclosure.

FIG. 31 is a schematic structural view of the contact support of the contactor provided by the third embodiment of the present disclosure in an unactivated state.

FIG. 32 is a schematic structural view of the contact support of the contactor provided by the third embodiment of the present disclosure in an activated state.

### DETAILED DESCRIPTION

In the following disclosure, the technical solution in the exemplary embodiment of the present disclosure will be described clearly and completely with the attached drawings. The exemplary embodiments described herein are only for illustration purposes, and are not used to limit the scope of protection of this disclosure, so it should be understood that various modifications and changes can be made to the exemplary embodiments without departing from the scope of protection of this disclosure.

In the description of the present disclosure, unless otherwise specified and limited, the terms “first” and “second” are only used for descriptive purposes and cannot be understood as indicating or implying relative importance. The term “plurality” refers to two or more. The term “and/or” includes any and all combinations of one or more associated listed items. In particular, reference to “the/described” object or “an” object is also intended to indicate one of a possible plurality of such objects.

Unless otherwise specified or stated, the terms “connect” and “fix” shall be broadly understood. For example, “connect” can be a fixed connection, detachable connection, integral connection, electrical connection, and/or signal connection; “connect” can be a direct connection or indirect connection through an intermediary component. For those skilled in the art, the specific meanings of the above terms in the present disclosure can be understood according to specific situations.

Further, in the description of this disclosure, it should be understood that, the locative words such as “up/top”, “down/bottom”, “inside”, and “outside” described in the exemplary embodiment of the present disclosure are described from the angle shown in the attached drawings, and should not be understood as limitations to the exemplary embodiment of the present disclosure. It should also be understood that, in this context, when it is mentioned that an element or feature is connected to the “upper”, “lower” or “inside” or “outside” of another element(s), it can not only be directly connected to the “upper”, “lower”, “inside”, or “outside” of the other element(s), but also be indirectly connected to the “upper”, “lower”, “inside”, or “outside” of the other element(s) through an intermediate element.

Exemplary embodiments will now be described more fully with reference to the accompanying drawings. However, the exemplary embodiments can be implemented in various forms and should not be construed as limited to the embodiments set forth herein. Rather, these embodiments are provided so that this disclosure will be thorough and complete, and will fully convey the concepts of exemplary embodiments to those skilled in the art. The same reference numerals in the drawings indicate the same or similar structures, so their detailed description will be omitted.

### First Embodiment

The embodiments of the present disclosure provide an air conditioning system, which can be used in buildings of residential or commercial buildings, and uses the power grid to provide needed power for the air conditioning system, where, the power grid is specifically an interconnection network that transmits power from producers to consumers.

The air conditioning system provided by the present disclosure includes an outdoor unit, an indoor unit, and a compressor, and the compressor is used for circulating the refrigerant between the outdoor unit and the indoor unit to achieve the purpose of refrigeration.

There is refrigerant in the air conditioning system, such as A2L refrigerant. Where, “A” indicates that the refrigerant has an occupational exposure limits (OEL) of ppm or more, according to the burning velocity (BV), heat of combustion (HOC), and lower flammability limit (LFL) of a specific refrigerant, it can be divided into different grades such as the first grade, the second grade and the third grade, the second grade is specifically divided into “2L” and “2”, and the grade of “2L” shows that although the refrigerant is still considered flammable, its flammability is far lower than the second or third grade.

If A2L refrigerant is exposed to an energy source with high enough energy, A2L refrigerant will be ignited. To this end, an air conditioning system is provided by the embodiments of the present disclosure, the air conditioning system includes a contactor for controlling power supply to an outdoor unit. When the contactor is connected or disconnected with the circuit, the potential ignition of refrigerant can be alleviated or blocked by using the contactor.

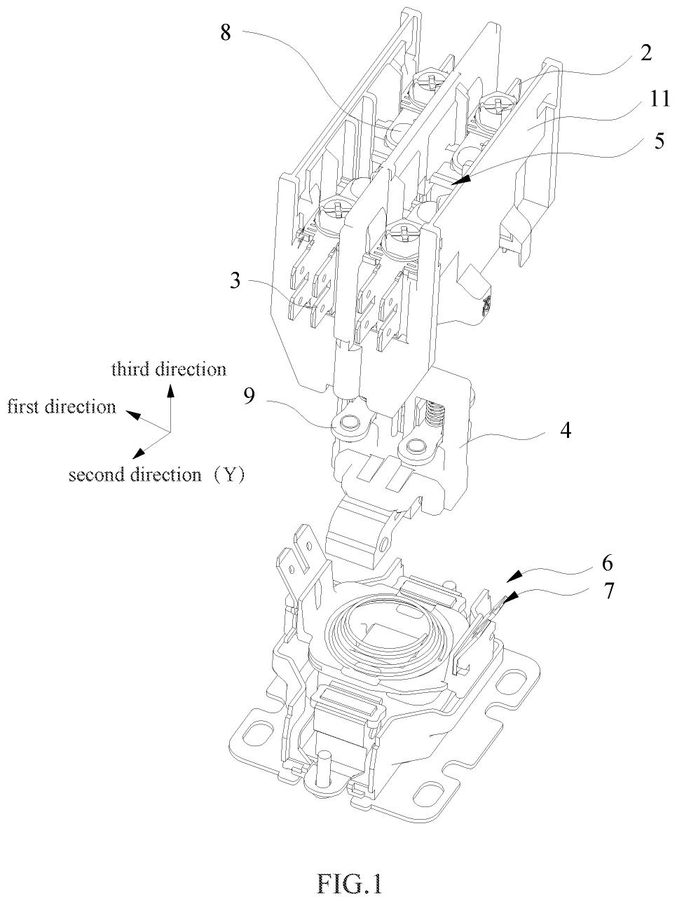

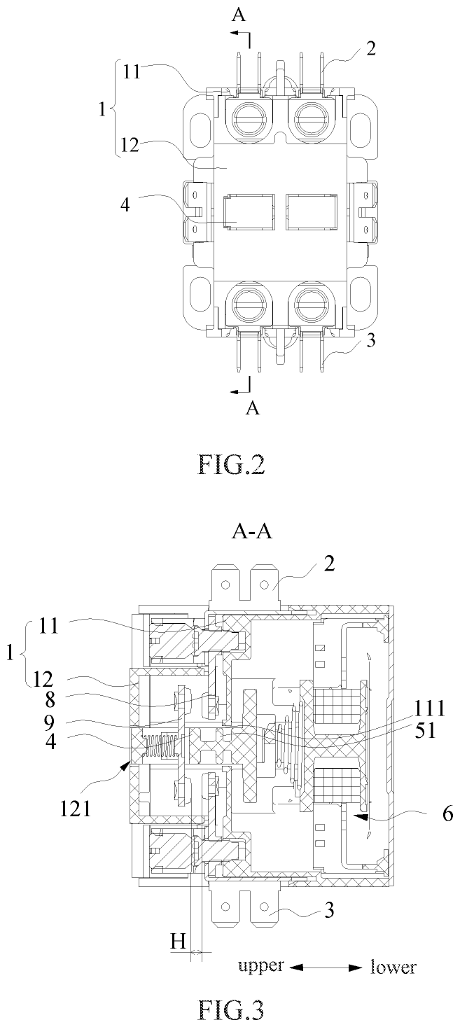

As shown in FIG. 1 to FIG. 2, the contactor provided by the embodiment includes a main body 1, a contact unit, and an electromagnetic unit 6. The main body 1 is provided with a first opening 13, the contact unit is disposed in the main body 1, where the contact unit includes a movable contact part 9 and a stationary contact part 8, and the electromagnetic unit 6 is disposed in the main body 1, and is used for controlling the movable contact part 9 to contact with or separate from the stationary contact part 8.

In the contactor provided by the embodiment, the electromagnetic unit 6 is used to control the movable contact part 9 to contact with or separate from the stationary contact part 8. When the movable contact of the movable contact part 9 is in contact with the stationary contact of the stationary contact part 8, the current flows in from one stationary contact part 8 and flows out from the other stationary contact part 8 after passing through the movable contact part 9, thus realizing the communication with the load. When the movable contact of the movable contact part 9 and the stationary contact of the stationary contact part 8 are separated, the transmission path of current between the stationary contact part 8 and the movable contact part 9 is cut off, thus realizing the load cutting-off process.

As the movable contact of the movable contact part 9 and the stationary contact of the stationary contact part 8 are separated, an arc will be magnetically blown between the movable contact part 9 and the stationary contact part 8. If the arc is elongated to a certain extent, the movable contact and the stationary contact corresponding to the movable contact part 9 and the stationary contact part 8 will be automatically opened. If the arc touches the refrigerant, the refrigerant will be ignited.

As shown in FIG. 1, the contactor provided by the embodiment further includes an isolation structure 5, which is disposed between the electromagnetic unit 6 and the contact unit, and is used for blocking the refrigerant entering from the first opening 13 from entering the space where the movable contact part 9 and the stationary contact part 8 contact each other through the electromagnetic unit 6.

In the contactor provided by the embodiment, the isolation structure 5 is disposed in the main body 1 and between the electromagnetic unit 6 and the contact unit. The isolation structure 5 can cut off and block the path of the refrigerant entering the contact unit from the electromagnetic unit 6, thus reducing the refrigerant from entering between the movable contact part 9 and the stationary contact part 8, and further reducing the risk of refrigerant ignition under the action of the electric arc.

In some cases, alleviating the potential ignition of A2L refrigerant may mean preventing the flame from spreading outside the contactor. For example, if the refrigerant is in contact with the circuit in the contactor when the refrigerant is ignited, the isolation structure 5 also functions to isolate the flame so that the flame will not spread outside the contactor.

In one embodiment, as shown in FIG. 1 to FIG. 2, the contactor further includes a first electrical terminal 2 and a second electrical terminal 3, and the first electrical terminal 2 and the second electrical terminal 3 are disposed on the main body 1 and respectively connected to a pair of stationary contact parts 8. The first electrical terminal 2 may also be referred to as a line-side electrical terminal, and is configured to receive power from the power grid. The second electrical terminal 3 may also be referred to as a load-side electrical terminal, and is configured to transmit at least part of electric power to the load.

It can be understood that the first electrical terminal 2 is disposed on one side of the main body 1 and the second electrical terminal 3 is disposed on the other side of the main body 1. Of course, in some other embodiments, the first electrical terminal 2 and the second electrical terminal 3 can also be disposed on the same side or two adjacent sides of the main body 1, in the embodiment, the positions of the first electrical terminal 2 and the second electrical terminal 3 are not limited, and can be adjusted according to actual conditions (e.g., production conditions).

In one embodiment, as shown in FIG. 1 to FIG. 3, the contact unit also includes a contact support 4, the main body 1 is provided with a through hole 111, the contact support 4 is configured to penetrate through the through hole 111 and is in sliding fit with it, and the contact support 4 is used for carrying the movable contact part 9.

The contact support 4 is in sliding fit with the through hole 111 of the main body 1, and the through hole 111 plays the role of guiding the contact support 4. Because the contact support 4 carries the movable contact part 9, the contact support 4 can drive the movable contact part 9 to move towards or away from the stationary contact part 8 for contact and separation between the movable contact part 9 and the stationary contact part 8.

The contact support 4 is disposed between the first electrical terminal 2 and the second electrical terminal 3. The contact support 4 can also be called a switching element, and is used to control the supply of power to loads such as the outdoor unit. When the contact support 4 is activated, the contact support 4 can drive the movable contact part 9 to move towards the stationary contact part 8 until the movable contact part 9 contacts the stationary contact part 8, so that the first electrical terminal 2 is electrically connected to the second electrical terminal 3. After the first electrical terminal 2 receives power from the power grid, it can transmit at least part of the power to the load such as the outdoor unit. When the contact support 4 is not activated, the electrical connection between the first electrical terminal 2 and the second electrical terminal 3 is broken, cutting off the path of power transmission to the load.

In one embodiment, there are a plurality of the first electrical terminals 2 and the second electrical terminals 3, and one contact support 4, a plurality of first electrical terminals 2 and a plurality of second electrical terminals 3 are correspondingly disposed.

In one embodiment, as shown in FIG. 1 to FIG. 3, the contactor also includes a connection terminal 7. The connection terminal 7 is specifically the lead-out end of the coil, and the iron core penetrates through the coil and at least part is located in the coil. When the connection terminal 7 is energized, the iron core can generate a magnetic field under the action of the energized coil and, when the magnetic field exists, the magnetic field can activate the contact support 4. For example, the iron core pulls the contact support 4 inward, causing one or more stationary contact parts 8 and the movable contact part 9 to close, allowing the power to be transmitted between the first electrical terminal 2 and the second electrical terminal 3. When the magnetic field does not exist, the stationary contact part 8 and the movable contact part 9 remain open, and the power cannot be transmitted from the first electrical terminal 2 to the second electrical terminal 3. The generation of the magnetic field depends on the power supplied to the connection terminal 7 of the coil of the electromagnetic unit. For example, if the power supply is turned off, the magnetic field may not exist, which means that the stationary contact part 8 and the movable contact part 9 will remain open.

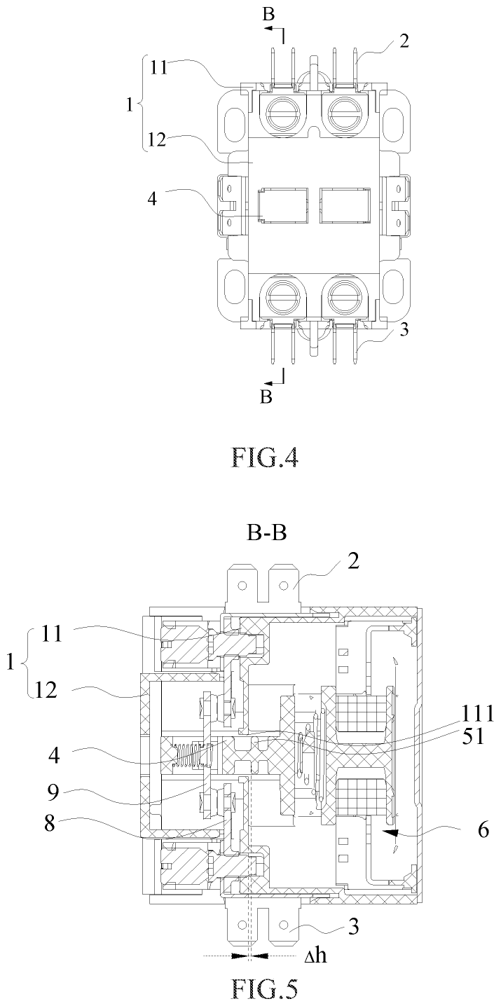

In one embodiment, as shown in FIG. 2 to FIG. 5, the isolation structure 5 is disposed between the side of the stationary contact part 8 away from the movable contact part 9 and the electromagnetic unit 6.

Since the side of the movable contact part 9 facing the stationary contact part 8 needs to be in contact with the stationary contact part 8, and the movable contact part 9 and the stationary contact part 8 will generate an arc in the contact or separation process, the isolation structure 5 is disposed between the side of the stationary contact part 8 far away from the movable contact part 9 and the electromagnetic unit 6. That is, the isolation structure 5 is not disposed in the area where the arc is directly generated. If the refrigerant enters the electromagnetic unit 6 through the first opening 13, the isolation structure 5 blocks the refrigerant out of the area where the arc is generated, and prevents the refrigerant from contacting with the arc, thereby avoiding the risk of ignition of the refrigerant.

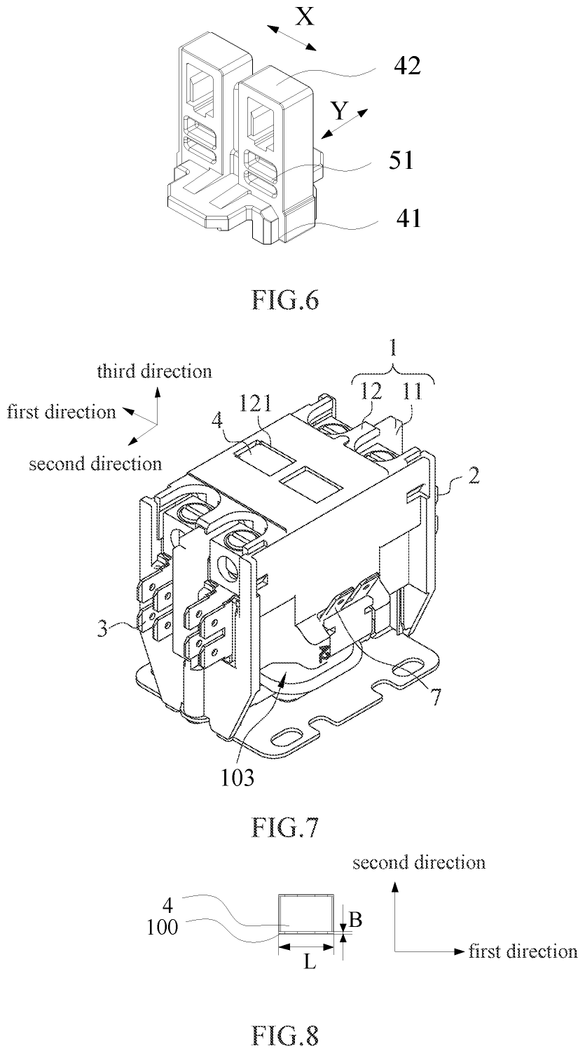

In one embodiment, as shown in FIG. 6, the isolation structure 5 is disposed on the contact support 4.

The isolation structure 5 is disposed on the contact support 4, which can move with the movement of the contact support 4 without affecting the smoothness of the contact support 4 in the movement process, and no matter where the contact support 4 moves, the position of the isolation structure 5 relative to the contact support 4 is fixed. That is, the distance between the isolation structure 5 and the movable contact part 9 is fixed, and the isolation structure 5 can continuously maintain the isolation between the electromagnetic unit 6 and the movable contact part 9.

In one embodiment, as shown in FIG. 6, the isolation structure 5 includes an isolation rib 51 protruding from the outer wall of the contact support 4.

The isolation ribs 51 are protruded on the outer wall of the contact support 4 to strengthen the structural strength of the contact support 4. If the refrigerant flows from the electromagnetic unit 6 to the outer wall of the contact support 4 from bottom to top, and the isolation rib 51 is higher than the outer wall of the contact support 4, the isolation rib 51 will block the refrigerant and confine the refrigerant to the side of the isolation rib 51 far away from the movable contact part 9, so as to isolate the path of the refrigerant from the electromagnetic unit 6 to the contact unit. In addition, the isolation rib 51 can be adapted to the movement track of the contact support 4 to the greatest extent, so as to block the refrigerant from igniting and generating flame during the movement of the contact support 4.

In one embodiment, as shown in FIG. 6, the isolation rib 51 extends in the width direction X of the movable contact part 9.

As the two ends of the movable contact part 9 along its length direction Y are respectively provided with two movable contacts, a pair of stationary contact parts 8 are provided with two stationary contacts corresponding to the two movable contacts, an arc can be generated between the movable contact and stationary contact, the isolation rib 51 is configured to extend in the width direction X of the movable contact part 9, and can cut off or block the flow path of the refrigerant to a certain extent, so that there is no conditions for igniting the A2L refrigerant.

In one embodiment, there are a plurality of isolation ribs 51, and the plurality of isolation ribs 51 are respectively disposed on both sides of the contact support 4 along the length direction Y of the movable contact part 9.

It can be understood that both sides of the contact support 4 are provided with the isolation ribs 51, and at least two isolation ribs 51 can be provided along the length direction of the movable contact part 9 to further cut off or block the flow path of the refrigerant.

It can be understood that the isolation rib 51 can be an integral structure, and the isolation rib 51 is disposed on the outer wall of the contact support 4 in a straight line, the isolation rib 51 can be a continuous structure, which can completely isolate the refrigerant with good isolation effect.

The isolation rib 51 can also be a split structure, and the isolation rib 51 includes a plurality of isolation monomers which are disposed at intervals along the width direction of the movable contact part 9. In some other embodiments, a single insulating monomer may be provided on the contact support 4. The single insulating monomer can be arranged at one side or the middle position of the contact support 4, so long as the isolation effect can be achieved, this embodiment is not limited here.

In one embodiment, the isolation structure 5 and the contact support 4 are integrally formed. The adoption of integrated structure can reduce the links of parts assembly and reduce the production cost.

In one embodiment, the isolation structure 5 further includes a support rib (not shown), which is disposed on the outer wall of the contact support 4 and connected to the isolation rib 51.

Because the support rib is disposed on the outer wall of the contact support 4, it plays a role in strengthening the structure of the contact support 4. The support rib is connected to the isolation rib 51, which increases the fixing strength of the isolation rib 51 relative to the contact support 4, so as to improve the reliability of blocking the refrigerant.

It can be understood that the support rib can be arranged vertically or obliquely with respect to the length direction Y of the movable contact part 9. The support rib can also be a single rib or a rib net. In the embodiment, the structure, shape, and position of the support rib are not limited. So long as the supporting effect of the isolation rib 51 can be achieved, it is within the protection scope of this embodiment.

If the isolation structure 5 and the contact support 4 are made of non-abrasive thermosetting materials, when the contact support 4 moves, the isolation structure 5 and the main body 1, and the contact support 4 and the main body 1 will rub against each other, resulting in a large amount of dust.

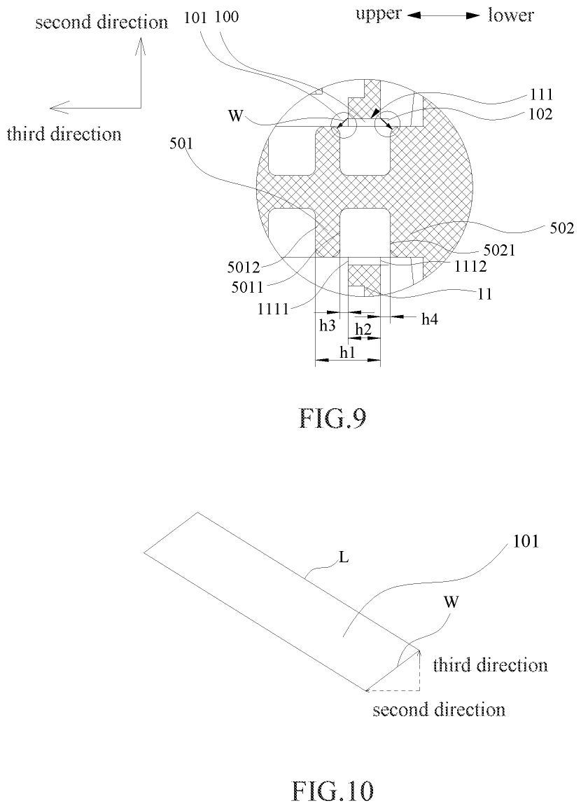

In order to solve this problem, as shown in FIG. 8 to FIG. 9, the contact support 4 and the isolation structure 5 can be made of at least one of self-lubricating materials and wear-resistant materials. For example, PA66, PA6, PBT (polybutylene terephthalate), and PET (Polyethylene terephthalate) and so on can be selected as wear-resistant materials, among which PA66 and PA6 belong to PA (Polyamide), and PA can also be collectively referred to as nylon.

When the contact support 4 moves, the isolation structure 5 and the main body 1, and the contact support 4 and the main body 1 will rub against each other. The isolation structure 5 and the contact support 4 have certain wear resistance, which can reduce the dust generated during the movement, improve the environmental protection effect, and prolong the product life.

In one embodiment, as shown in FIG. 7, the main body 1 includes a housing 11 and a cover plate 12, where, the contact unit, the electromagnetic unit 6 and the isolation structure 5 are disposed in the housing 11, and the housing 11 is provided with an open end. The cover plate 12 covers the open end of the housing 11.

The cover plate 12 is disposed at the open end of the housing 11, which is equivalent to covering the top of the housing 11 to form a frame structure for supporting the contact support 4, the first electrical terminal 2, and the second electrical terminal 3.

In one embodiment, the first opening 13 is provided on the main body 1 and corresponds to the electromagnetic unit 6.

The first opening 13 is not provided on the cover plate 12, but is provided corresponding to the electromagnetic unit 6. That is, the first opening 13 is not provided at the top position of the main body 1, but at the lower position such that the refrigerant may enter the main body 1 from bottom to top.

The top surface of the main body 1 is also provided with a second opening 121, and the contact support 4 is disposed corresponding to the second opening 121 of the main body 1, and the second opening 121 is used to alleviate the potential ignition of the refrigerant to avoid the burning of the refrigerant under the action of electric arc.

In one embodiment, as shown in FIG. 6 to FIG. 7, the contact support 4 includes a bracket 41 and an indicator 42 disposed at the top of the bracket 41, and the indicator 42 is configured to penetrate through the second opening 121 and is in sliding fit with thereof.

The indicator 42 protrudes from the top surface of the bracket 41, and the indicator 42 can penetrate through the second opening 121. The operator can observe the position of the indicator 42 through the second opening 121, which is used to indicate whether the contact support 4 is currently in a triggered state or an un-triggered state or a stuck state.

The effective opening size of the contactor meets the following requirements and can be judged as a non-potential ignition source:

$${d}_{eff} \leq 22.3 \times {Su}^{- 1.09} ( in mm ) \leq 7 mm \qquad Formula 1$$

Taking the second opening 121 as an example, d_{eff} represents the effective opening size of the second opening 121 in mm; Su represents the burning velocity of the refrigerant, in cm/s.

For example, if the burning velocity Su of A2L refrigerant R32 is 6.7 cm/s, then 22.3×6.7−1.09=2.8 mm.

According to appendix JJ of UL 60335-2-40, the effective opening of the contactor is calculated as follows:

$${d}_{eff} = 4 \times A / S \qquad Formula 2$$

A represents the area of the second opening 121 in mm²; S represents the perimeter length of the second opening 121 in mm.

Therefore, so long as the effective opening size of the second opening 121 in the contactor is limited to be smaller than the opening limit requirement of the corresponding refrigerant, the contactor can be applied in the air conditioning system with A2L refrigerant.

The second opening 121 is a rectangular through hole, and the extending direction of the long side of the second opening 121 is defined as the first direction, or the width direction of the movable contact part 9 is defined as the first direction. The extending direction of the short side of the second opening 121 is the second direction, or the length direction Y of the movable contact part 9 is the second direction, and the depth direction of the through hole 111 is the third direction, or the movement direction of the movable contact part 9 relative to the stationary contact part 8 is the third direction. The first direction, the second direction, and the third direction are perpendicular to each other. The first direction, the second direction, and the third direction only represent the spatial direction and have no substantive significance.

By limiting the size of the second opening 121, the requirements of the standard opening limit can be met, and the observation function can be retained by using the second opening 121.

Specifically, as shown in FIG. 8, a gap 100 is provided between the isolation structure 5 and the through hole 111. The effective opening size d_{eff} of the gap 100 is less than or equal to the threshold size of the standard opening limit.

For example, the length L of the gap 100 in the first direction is 11.5 mm, and the width B of the gap 100 in the second direction is 0.5 mm, the effective opening size of the gap 100 is d_{eff}=4×A/S=(11.5*0.5)*4/((11.5+0.5)*2)=0.96 mm, then d_{eff}<22.3×Su^{-1.09} (in mm)=2.8 mm.

The gap 100 is provided between the through hole 111 and the isolation structure 5, and the effective opening size of the gap 100 is limited, which can produce a quenching effect, prevent or at least alleviate the contact between A2L refrigerant and the circuit in the contactor, and also prevent the flame from spreading outside the contactor, so that the contactor has the function of compatibility with A2L refrigerant, which is beneficial to alleviating the potential ignition of A2L refrigerant.

In one embodiment, the threshold size of the standard opening limit is 2.8 mm.

The threshold size of the standard opening limit is matched with A2L refrigerant, and the threshold size of the standard opening limit can be calculated according to the burning velocity Su of A2L refrigerant, which can directly at least alleviate, prevent, or block the potential ignition of A2L refrigerant.

For a specific A2L refrigerant, the limit value of the effective opening is calculated according to the above Formula 1, and it is assumed to be d_{eff}. For a specific contactor, it can be calculated that the effective opening of the contact support 4 to the electromagnetic unit 6 is d_{eff} according to Formula 2. As long as d_{eff}2<d_{eff}≤7 mm according to the standard requirements, the product can be judged as a non-ignition source.

As shown in FIG. 9 to FIG. 10, in the contactor provided by the embodiment, the isolation structure 5 includes a first isolation structure 501 and a second isolation structure 502. The first isolation structure 501 can pass through the through hole 111, and the second isolation structure 502 is disposed between the through hole 111 and the electromagnetic unit 6. When the movable contact part 9 and the stationary contact part 8 are in the released state, the first isolation structure 501 and the second isolation structure 502 are disposed at both sides of the through hole 111 along the attraction direction (that is, the third direction) of the movable contact part 9 and the stationary contact part 8. The first isolation structure 501 and the second isolation structure 502 can limit the effective opening size d_{eff} of the contact support 4 to the electromagnetic unit 6, so that the effective opening of the contactor can meet the requirements of non-ignition sources in the standard.

There are two openings between the gap 100 and the contact support 4. One of the two openings near the contact support 4 is a first sub-opening 101, and the other one near the electromagnetic unit 6 is a second sub-opening 102. The two openings can be equivalent to a rectangle. For a specific contactor, the length of the opening is certain, as shown in FIG. 9 and FIG. 10, the length L of the opening (the first sub-opening 101 or the second sub-opening 102) extends along the direction perpendicular to the first direction and the third direction (that is, the direction perpendicular to the paper), and the size of the width W of the opening is related to the positions of the first isolation structure 501 and the second isolation structure 502. The width W is shown by the solid arrow in FIG. 9. As shown in FIG. 10, the width W can be decomposed into a component projected in the second direction and a component projected in the third direction. The component of the width in the second direction is the mating gap 100 between the contact support 4 and the through hole 111, for a specific contactor, the component projected in the second direction is generally a certain value. Therefore, so long as the component along the third direction is limited to a reasonable value, the effective opening of the contact support 4 corresponding to the electromagnetic unit 6 can meet the requirements of the standard non-ignition source. Assume that the maximum value is hmax.

When the contact support 4 has the first isolation structure 501 and the second isolation structure 502, the opening needs to meet the requirements during the movement of the contact support 4 of the contactor in the third direction.

When the movable contact part 9 and the stationary contact part 8 are in the release state, the first isolation structure 501 and the second isolation structure 502 are disposed at both sides of the through hole 111 along the attraction direction of the movable contact part 9 and the stationary contact part 8, and (h3+h4)/2≤hmax.

When the movable contact part 9 and the stationary contact part 8 is in the released state, H−h1≤hmax.

H is the attraction distance of the movable contact part 9 relative to the stationary contact part 8, h1 is the distance between the side of the first isolation structure 501 and the side of the through hole 111, the two sides are far away from each other in the attraction direction of the movable contact part 9 and the stationary contact part 8, h3 is the distance between the side of the first isolation structure 501 and the side of the through hole 111, the two sides are close to each other in the attraction direction of the movable contact part 9 and the stationary contact part 8, h4 is the distance between the side of the second isolation structure 502 and the side of the through hole 111, and the two sides are close to each other in the attraction direction of the movable contact part 9 and the stationary contact part 8.

It can be understood that, in the process of the movable contact part 9 and the stationary contact part 8 from the release state to the suction state, there are the first sub-opening 101 and the second sub-opening 102. It is enough that the smaller of the two sub-openings meets the requirements. During the process from release to attraction of the movable contact part 9 and the stationary contact part 8, the distance that the contact support 4 will move in the third direction relative to the through hole 111 is h, at this time, if the first isolation structure 501 is passing through the through hole 111, or the first isolation structure 501 is at least partially located in the through hole 111, or the first isolation structure 501 is located outside the through hole 111, then the distance between the side of the first isolation structure 501 away the electromagnetic unit 6 in the third direction and the through hole III is H−h1, and H−h1 needs to meet the requirements.

In particular, h1, h3, and h4 can be a positive value or a negative value. Assuming the position shown in FIG. 9, h3 and h4 are positive values, that is, when the lower surface 5011 of the first isolation structure 501 of the contact support 4 is located above the upper end 1111 of the through hole 111 in the third direction, h3 is positive. When the lower surface 5011 of the first isolation structure 501 of the contact support 4 is flush with the upper end 1111 of the through hole 111 in the third direction, h3 is 0. When the lower surface 5011 of the first isolation structure 501 of the contact support 4 is below the upper end 1111 of the through hole 111 in the third direction, h3 is negative. Similarly, when the lower end 1112 of the through hole III in the third direction is located above the upper surface 5021 of the second isolation structure 502 of the contact support 4, h4 is positive, and when lower end 1112 and the upper surface 5021 are flush, h4 is zero, and when the lower end 1112 is located below the upper surface 5021, h4 is negative. The depth h2 of the through hole 111 in the third direction is not limited, h2 may be greater than the height of h1, and the size relationship between H and h1 may not be limited. In another embodiment, H can also indicate the distance between the armature and the yoke.

When the coil of the contactor is energized, the contact support 4 moves in the third direction and towards the electromagnetic unit 6, while the upper surface 5012 of the first isolation structure 501 does not leave the lower end 1112 of the through hole 111, the first sub-opening 101 gradually becomes smaller and the second sub-opening 102 becomes larger.

When the coil is not energized, the components of the first sub-opening 101 and the second sub-opening 102 in the second direction are h3 and h4, respectively

It is assumed that the displacement of the contact support 4 is Δx, the width component of the first sub-opening 101 in the second direction is h3′, and h3′=h3−Δx, the width component of the second sub-opening 102 in the second direction is h4′, and h4′=h4+Δx.

Since the effective opening d_{eff}=min (h3′, h4′), it meets the requirements when h3′=h4′≤hmax, and other positions of the contact support 4 can also meet the requirements. That is, require (h3′+h4′)/2=(h3−Δx+h4+Δx)/2=(h3+h4)/2≤hmax.

When the upper surface 5012 of the first isolation structure 501 of the contact support 4 leaves the lower end 1112 of the through hole 111 until the contactor is attracted, the width component of the second sub-opening 102 in the third direction is Δh as shown in the figure, so only Δh≤hmax is required.

Therefore, in the process of the contactor attraction, the distance that the contact support 4 moves in the second direction is H, where H is specifically the gap between the contacts or H is the gap of the iron core. When the coil is not energized, the distance between the upper surface 5012 of the first isolation structure 501 of the contact support 4 and the lower end 1112 of the through hole III is h1. It can be calculated that Δh=H−h1, therefore, only H−h1≤hmax is required.

To sum up, in the static state, that is, when the movable contact part 8 and the stationary contact part 9 are in the released state, only (h3+h4)/2≤hmax and H−h1≤hmax need to be set.

In one embodiment, the isolation structure 5 includes a first isolation structure 501 that can pass through the through hole 111. When the movable contact part 9 and the stationary contact part 8 are in the released state, the first isolation structure 501 is disposed at the side of the through hole 111 far away from the electromagnetic unit 6, h3≤hmax. When the movable contact part 9 and the stationary contact part 8 are in the released state, H−h1≤hmax.

It can be understood that the second isolation structure 502 is not necessary, when the contact support 4 only has the first isolation structure 501, or when the first isolation structure 501 and the second isolation structure 502 of the contact support 4 are integrated, the second opening 121 between the first isolation structure 501 and the through hole 111 needs to meet the requirements.

### Second Embodiment

This embodiment is similar to the first embodiment, and the difference is only that the isolation structure 5 is disposed in different positions.

As shown in FIG. 11, the isolation structure 5 provided in this embodiment is disposed in the main body 1.

The isolation structure 5 is disposed in the main body 1 and between the electromagnetic unit 6 and the contact unit, so that the path of the refrigerant entering the contact unit from the electromagnetic unit 6 can be cut off and blocked, and the risk of refrigerant entering between the movable contact part 9 and the stationary contact part 8 and igniting under the action of electric arc can be reduced.

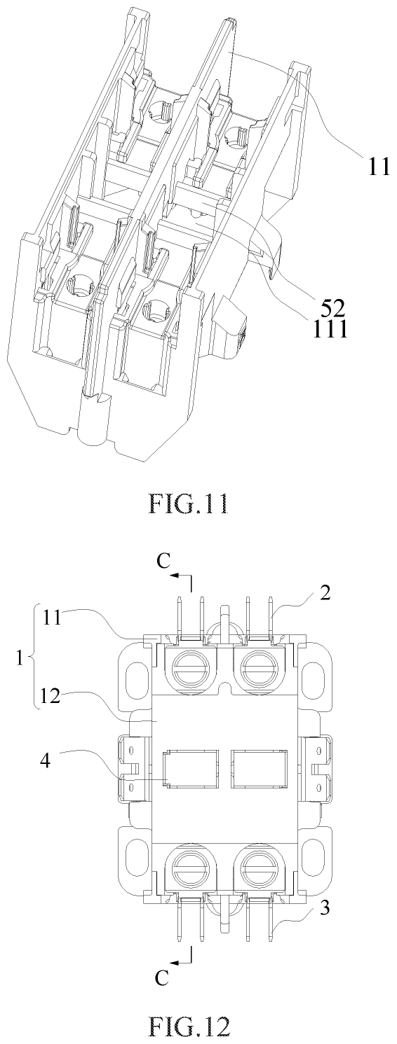

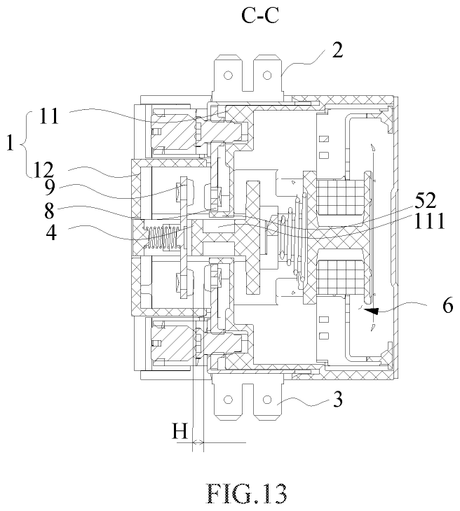

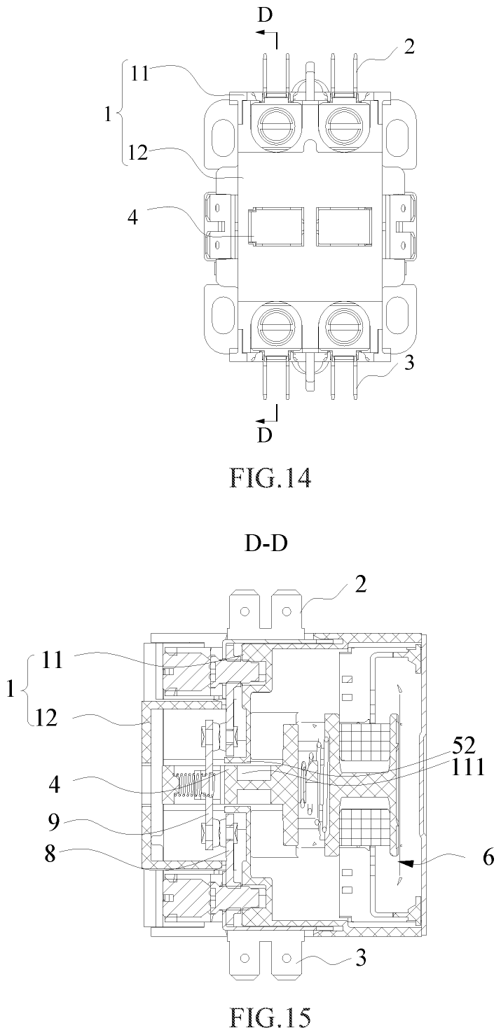

In one embodiment, as shown in FIG. 11 to FIG. 15, the isolation structure 5 includes one or more barrier ribs 52 which at least partially surround the outside of the contact support 4 and is connected to the inner wall of the main body 1.

The barrier rib 52 at least partially surrounds the outside of the contact support 4, and plays a role in encircling and surrounding the contact support 4, so that the through hole 111 can meet the limit requirement of A2L refrigerant during the whole movement of the contact support 4. Without the barrier rib 52, when the contact support 4 moves to a certain position, the limit of the through hole 111 will exceed the standard opening limit.

It can be understood that the barrier rib 52 can be specifically disposed on the inner wall of the through hole 111 or along the edge of the through hole 111, which can block or cut off the path of the refrigerant entering the contact unit from the electromagnetic unit 6 and meet the requirements of the through hole 111 corresponding to the refrigerant limit.

In one embodiment, the barrier rib 52 is configured to extend along the movement direction of the contact support 4, and/or the barrier rib 52 is configured to extend in the width direction X of the movable contact part 9.

When the barrier rib 52 of the isolation structure 5 is disposed along the edge of the through hole 111, a gap 100 is provided between the barrier rib 52 of the isolation structure 5 and the contact support 4. The barrier rib 52 is configured to extend along the moving direction of the contact support 4, so that the gap 100 between the barrier rib 52 and the contact support 4 can meet the standard opening limit when the movable contact part 9 and the stationary contact part 8 are close to or away from each other.

As the two ends of the movable contact part 9 along its length direction Y are respectively provided with two movable contacts, a pair of stationary contact parts 8 are correspondingly provided with two stationary contacts. If an arc is generated between the movable and stationary contacts, the arc is generally generated in the moving direction of the movable contact part 9. The barrier rib 52 is provided to extend in the width direction of the movable contact part 9, so that the flow path of the refrigerant can be cut off or blocked to a certain extent, and the conditions for igniting A2L refrigerant are not met.

In one embodiment, the main body 1 and the isolation structure 5 are integrally formed. The integrated structure is adopted, which can reduce the links of parts assembly and have lower production cost.

In one embodiment, as shown in FIG. 11 to FIG. 15, the main body 1 includes at least two oppositely arranged vertical plates, and the barrier rib 52 is disposed between two adjacent vertical plates, the barrier rib 52 and the vertical plate can form an isolation structure 5 surrounding the contact support 4, by borrowing the structure of the existing main body 1, materials can be obtained locally, so that the cost of production raw materials is relatively low.

It should be noted that the effective opening between the barrier rib 52 and the contact support 4 is similar to that of the first embodiment, so it will not be described in detail.

It should be noted that the isolation structure 5 can also have isolation rib 51 disposed on the outer wall of the contact support 4 and isolation rib 52 disposed on the edge of the through hole 111, so as to further improve the barrier effect of the refrigerant.

### Third Embodiment

This embodiment is similar to the first and second embodiments, and the only difference is that the contactor models are different.

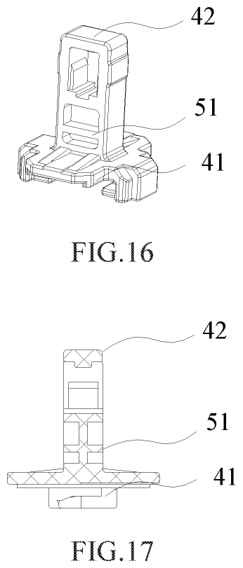

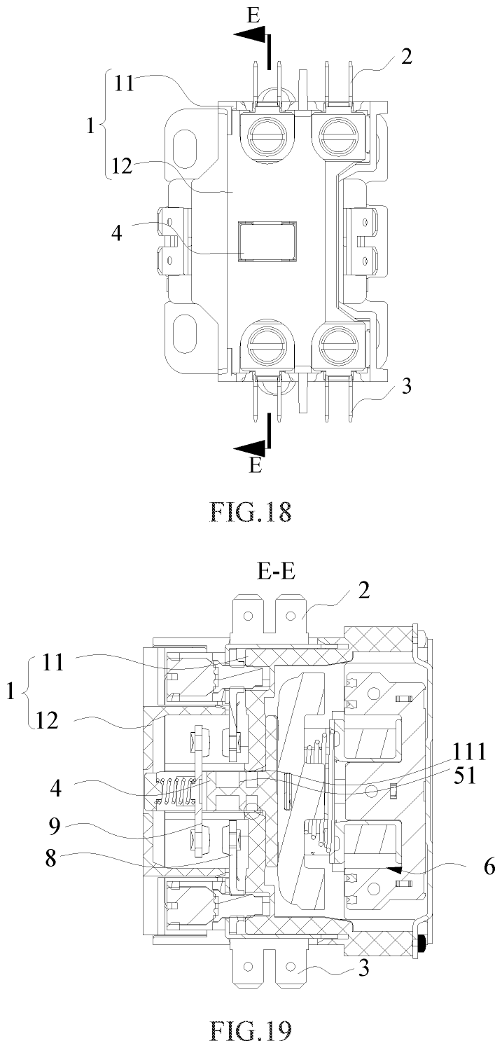

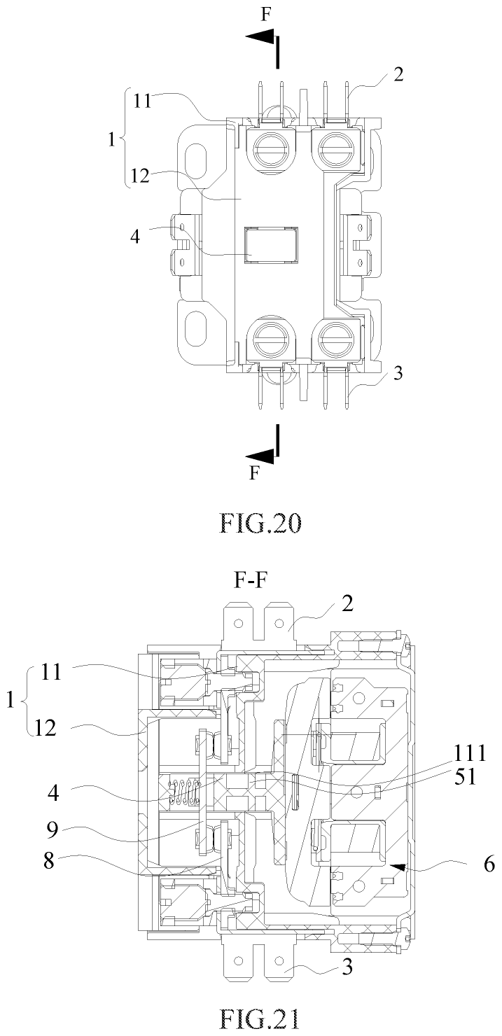

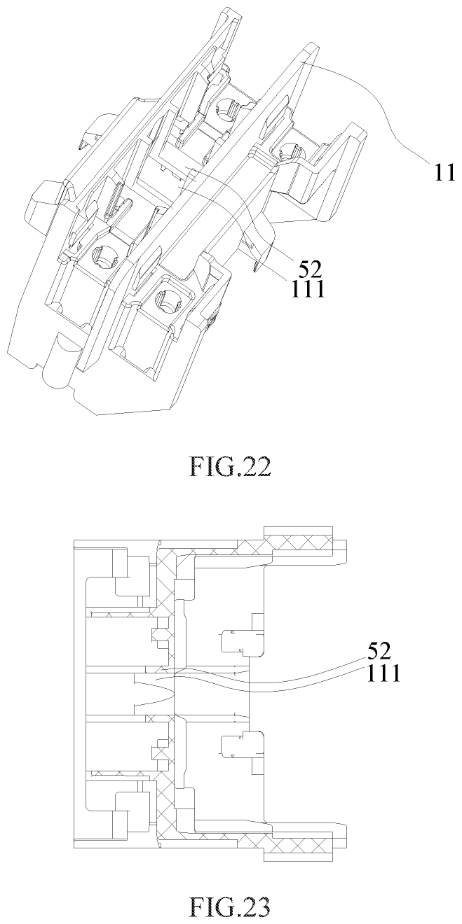

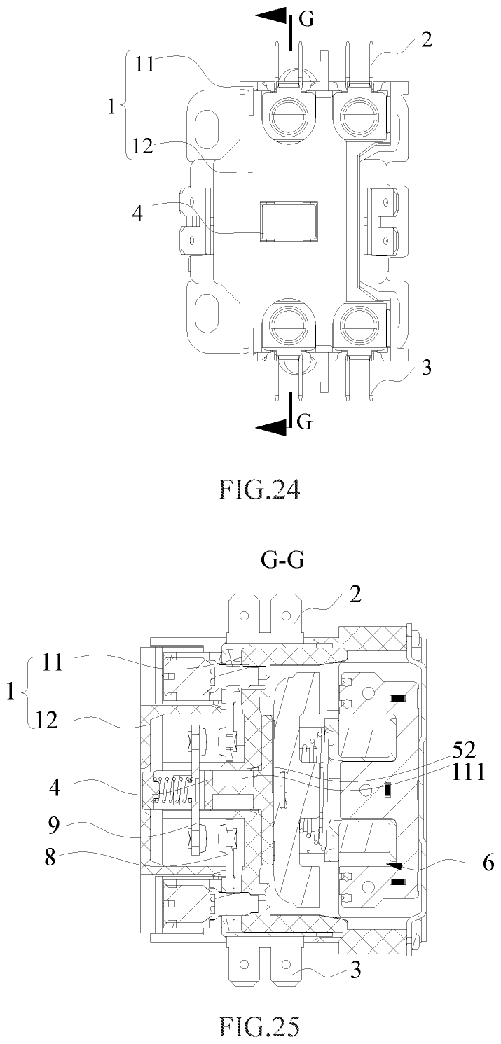

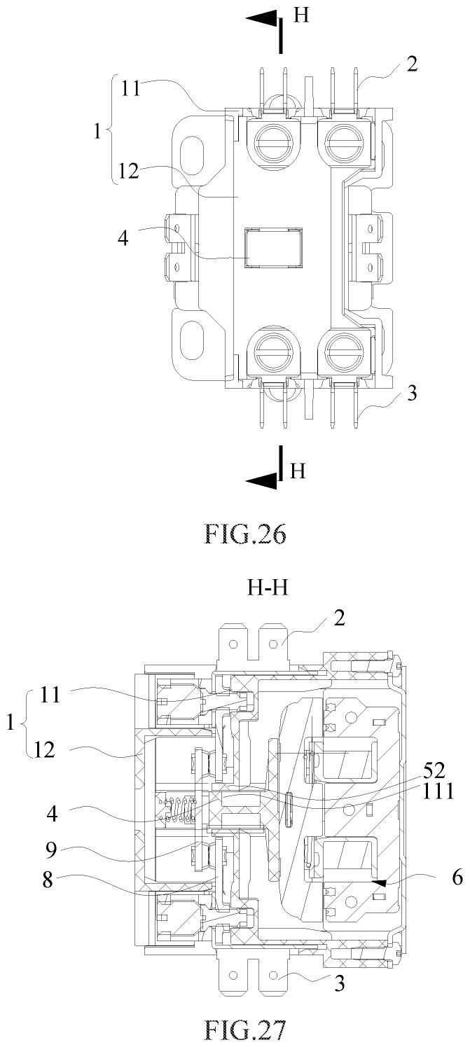

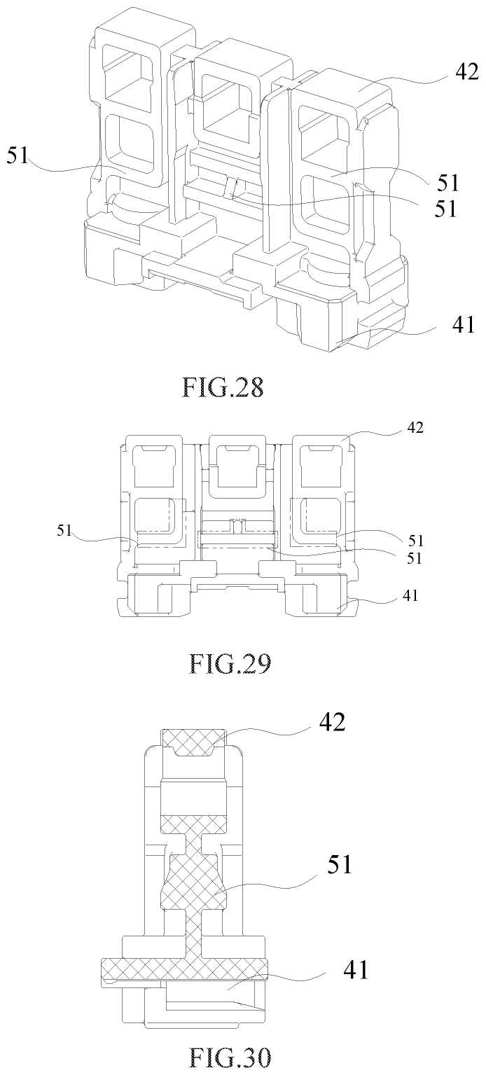

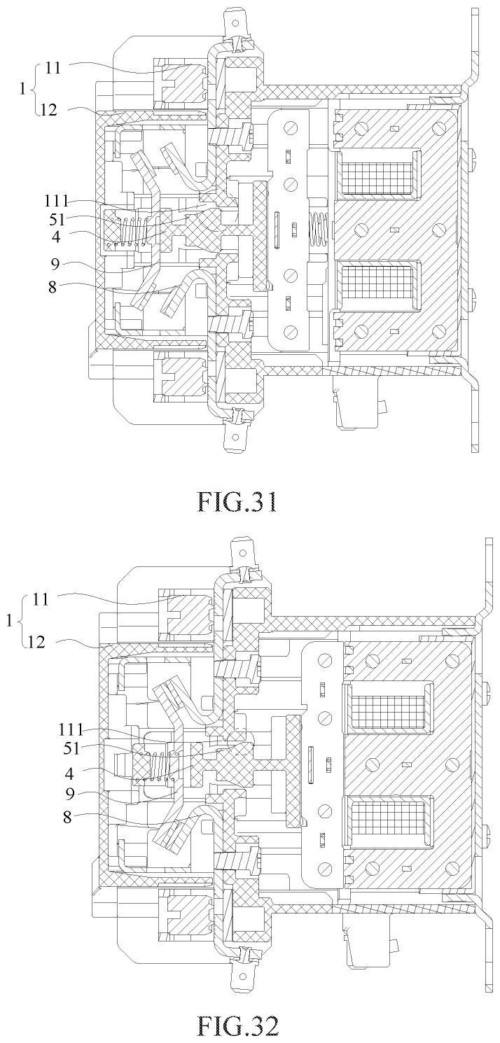

In different models of contactors, the numbers of the first electrical terminal 2 and the second electrical terminal 3 are different. For example, a contactor with model XMC0 1P (as shown in FIG. 16 to FIG. 27), a first electrical terminal 2 and a second electrical terminal 3 are correspondingly arranged to form a group of electrical terminals; a contactor with model XMC0 2P (as shown in FIG. 1 to FIG. 15), two first electrical terminals 2 and two second electrical terminals 3 are correspondingly arranged to form two groups of electrical terminals. The contactor with model XMC0 3P (as shown in FIG. 28 to FIG. 32) has three first electrical terminals 2 and three second electrical terminals 3 correspondingly arranged to form three groups of electrical terminals. The housing 11 and the contact support 4 can both be made of thermosetting materials.

In the embodiment, the numbers of the first electrical terminal 2 and the second electrical terminal 3 are not limited, and can be adjusted according to actual production needs. However, different groups of electrical terminals can correspond to one contact support 4 to ensure the synchronization of electrical connection.

In one embodiment, there are a plurality of second openings 121 and indicators 42 respectively, and the plurality of the indicators 42 are disposed corresponding to the plurality of second openings 121.

It can be understood that the number of the second openings 121 can be flexibly selected according to different models of contactors, it can be that one indicator 42 of one contact support 4 corresponds to one second opening 121, or a plurality of indicators 42 of one contact support 4 are all disposed on the bracket 41, and the plurality of indicators 42 correspond to a plurality of second openings 121. In the embodiment, the numbers of the second openings 121 and the indicating members 42 are not limited, as long as the second openings 121 and the indicators 42 can correspond to each other, which are within the protection scope of this embodiment.

It can be understood that for the contactor with model XMC0 3P, the sides of the three indicators 42 can be provided with isolation ribs 51, the shapes of the isolation ribs 51 corresponding to the three indicators 42 may be the same or different, for example, the isolation rib 51 located in the middle of the three isolation ribs 51 has an inverted T-shaped structure, while the other two isolation ribs 51 are similar to L-shaped structures. The thickness of the isolation ribs 51 corresponding to the three indicators 42 in the second direction may be the same or different, for example, among the three isolation ribs 51, the isolation rib 51 in the middle position is thicker in the second direction, while the other two isolation ribs 51 are thinner.

In the contactor provided by the embodiment of the present disclosure, the electromagnetic unit is used to control the contact or separation between the movable contact part and the stationary contact part. When the movable contact of the movable contact part is in contact with the stationary contact at the bottom of the stationary contact part, the current flows in from one stationary contact part and flows out from the other stationary contact part after passing through the movable contact part, so as to realize load communication. When the movable contact part is separated from the stationary contact of the stationary contact part, the transmission path of the current between the stationary contact part and the movable contact part is cut off, thus realizing the process of load cut-off. The isolation structure is disposed between the electromagnetic unit and the contact unit, the isolation structure can cut off and block the path of the refrigerant entering the contact unit from the electromagnetic unit, reduce the refrigerant entering the space where the movable contact part and the stationary contact part contact each other, and further reduce the risk of refrigerant ignition under the action of electric arc. The various embodiments described above can be combined with one another so long as a conflict does not exist between the embodiments.

It should be noted here that the contactor shown in the drawings and described in this specification is only one example of applying the principles of the present disclosure. It should be clearly understood by those skilled in the art that the principles of the present disclosure are not limited to any details or any components of the device shown in the drawings or described in the specification.

It should be understood that the present disclosure is not limited to the detailed structure and arrangement of components set forth in this specification. The present disclosure is capable of other embodiments and of being realized and carried out in various ways. The foregoing variations and modifications are within the scope of the present disclosure. It should be understood that the disclosure disclosed and defined in this specification extends to all alternative combinations of two or more individual features mentioned or readily apparent in the text and/or the drawings. All these different combinations constitute various alternative aspects of the present disclosure. The embodiments described in this specification illustrate the best modes known for carrying out the present disclosure and will enable those skilled in the art to make use of the present disclosure.

Other embodiments of the present disclosure will become apparent to those skilled in the art after considering the specification and practicing the creation disclosed herein. The present disclosure is intended to cover any variations, uses, or adaptations of this disclosure, which follow the general principles of the present disclosure and include common sense or common technical means in this technical field that are not disclosed in the present disclosure. The specification and the exemplary embodiments are to be regarded as exemplary only, with the true scope and spirit of the disclosure being indicated by the appended claims.

It should be understood that the present disclosure is not limited to the precise structure described above and shown in the drawings, and various modifications and changes can be made without departing from its scope. The scope of protection of the present disclosure is limited only by the appended claims.

What is claimed is:

1. A contactor, comprising:
a main body, which is provided with a first opening;
a contact unit, which is disposed in the main body, the contact unit comprising a movable contact part and a stationary contact part;
an electromagnetic unit, which is disposed in the main body, wherein the electromagnetic unit is configured to control the movable contact part to contact with or separate from the stationary contact part; and
an isolation structure, which is disposed between the electromagnetic unit and the contact unit, wherein the isolation structure is configured to block refrigerant entering from the first opening from entering a space where the movable contact part and the stationary contact part contact each other through the electromagnetic unit.

2. The contactor according to claim 1, wherein the isolation structure is disposed between a side of the stationary contact part away from the movable contact part and the electromagnetic unit.

3. The contactor according to claim 1, wherein the contact unit further comprises: a contact support, which is slidably disposed in the main body, and the contact support is configured to carry the movable contact part, wherein the isolation structure is disposed on the contact support.

4. The contactor according to claim 3, wherein the isolation structure is disposed in the main body.

5. The contactor according to claim 1, wherein the isolation structure is disposed in the main body.

6. The contactor according to claim 3, wherein the isolation structure comprises:
an isolation rib protruding from an outer wall of the contact support,
wherein the isolation rib is configured to extend along a width direction of the movable contact part; there are a plurality of isolation ribs, and the plurality of the isolation ribs are respectively disposed on both sides of the contact support along a length direction of the movable contact part.

7. The contactor according to claim 3, wherein the isolation structure comprises:
a barrier rib which at least partially surround an outside of the contact support and is connected to an inner wall of the main body,
wherein the barrier rib is configured to extend along a movement direction of the contact support.

8. The contactor according to claim 7, wherein the barrier rib is configured to extend along a width direction of the movable contact part.

9. The contactor according to claim 3, wherein the isolation structure comprises:
a barrier rib which at least partially surround an outside of the contact support and is connected to an inner wall of the main body,
wherein the barrier rib is configured to extend along a width direction of the movable contact part.

10. The contactor according to claim 3, wherein the isolation structure and the contact support are integrally formed.

11. The contactor according to claim 3, wherein the main body and the isolation structure are integrally formed.

12. The contactor according to claim 3, wherein:
the main body is provided with a through hole, and the contact support is configured to penetrate through the through hole and is in sliding fit with thereof;
a gap is provided between the isolation structure and the through hole; an effective opening size d_{eff} of the gap is less than or equal to a threshold size of a standard opening limit; the threshold size of the standard opening limit is 22.3×Su^{-1.09} (in mm); and
Su represents a burning velocity of refrigerant, in cm/s.

13. The contactor according to claim 3, wherein:
the isolation structure is disposed along an edge of the through hole and a gap is provided between the isolation structure and the contact support;
an effective opening size d_{eff} of the gap is less than or equal to a threshold size of a standard opening limit; the threshold size of the standard opening limit is 22.3×Su^{-1.09} (in mm); and
Su represents the burning velocity of refrigerant, in cm/s.

14. The contactor according to claim 12, wherein:
the isolation structure comprises a first isolation structure and a second isolation structure, the first isolation structure is capable of passing through the through hole, and the second isolation structure is disposed between the through hole and the electromagnetic unit;
when the movable contact part and the stationary contact part are in a release state, the first isolation structure and the second isolation structure are disposed at both sides of the through hole along an attraction direction of the movable contact part and the stationary contact part, and (h3+h4)/2≤hmax, H−h1≤hmax;
H is an attraction distance of the movable contact part relative to the stationary contact part, h1 is a distance between a side of the first isolation structure and a side of the through hole, two sides are far away from each other in the attraction direction of the movable contact part and the stationary contact part, h3 is a distance between a side of the first isolation structure and a side of the through hole, two sides are close to each other in the attraction direction of the movable contact part and the stationary contact part, h4 is a distance between a side of the second isolation structure and a side of the through hole, two sides are close to each other in the attraction direction of the movable contact part and the stationary contact part.

15. The contactor according to claim 12, wherein:
the isolation structure comprises a first isolation structure which is capable of passing through the through hole;
when the movable contact part and the stationary contact part are in a release state, the first isolation structure is disposed at a side of the through hole far away from the electromagnetic unit, h3≤hmax, H−h1≤hmax; and
H is an attraction distance of the movable contact part relative to the stationary contact part, h1 is a distance between a side of the first isolation structure and a side of the through hole, two sides are far away from each other in the attraction direction of the movable contact part and the stationary contact part, h3 is a distance between a side of the first isolation structure and a side of the through hole, two sides are close to each other in the attraction direction of the movable contact part and the stationary contact part.

16. The contactor according to claim 1, wherein the isolation structure is made of at least one of self-lubricating materials and wear-resistant materials.

17. The contactor according to claim 1, wherein the main body comprises:
a housing, wherein the contact unit, the electromagnetic unit, and the isolation structure are disposed in the housing, and the housing is provided with an open end; and
a cover plate, which is configured to cover the open end of the housing,
wherein the first opening is provided on the main body and corresponding to the electromagnetic unit.

18. An air conditioning system comprising a contactor, wherein the contactor comprises:
a main body, which is provided with a first opening;
a contact unit, which is disposed in the main body, the contact unit comprising a movable contact part and a stationary contact part;
an electromagnetic unit, which is disposed in the main body, wherein the electromagnetic unit is configured to control the movable contact part to contact with or separate from the stationary contact part; and
an isolation structure, which is disposed between the electromagnetic unit and the contact unit,
wherein the isolation structure is configured to block refrigerant entering from the first opening from entering a space where the movable contact part and the stationary contact part contact each other through the electromagnetic unit.
